(19) United States
(12) Patent Application Publication
(10) Pub. No.: US 2025/0219487 A1
(43) Pub. Date: Jul. 3, 2025

(54) INSET MAGNET WITH EARS

(71) Applicant: Schaeffler Technologies AG & Co. KG, Herzogenaurach (DE)

(72) Inventors: Sergio Ivan Aguilar Yanez, Puebla (MX); Antonio Cortes Ramirez, Puebla (MX)

(21) Appl. No.: 18/398,390

(22) Filed: Dec. 28, 2023

(51) Int. Cl. H02K 1/278; H02K 15/03

(52) U.S. Cl. CPC H02K 1/278; H02K 15/03; H02K 2201/03

(57) ABSTRACT

An electric motor including a stator, and a rotor supported for rotation within the stator. The rotor includes a rotor body having a plurality of radially extending magnet receiving slots opening to an outer circumference of the rotor, and a plurality of magnets received in the magnet receiving slots. An outer circumference of the rotor includes surfaces of the magnets and the rotor body.

### TECHNICAL FIELD

The present disclosure relates to a rotor for an electric motor. More particularly, the disclosure relates to a permanent magnet rotor.

### BACKGROUND

Permanent magnet electric motors typically include rotors having permanent magnets. The magnets are arranged and/or fastened to the rotor in a circumferential arrangement.

Various attachment structures are known in the prior art for arranging and/or attaching the magnets to the rotor. For example, the magnets can be overmolded on the rotor with a plastic material that retains the magnets to a body of the rotor. Mechanical fasteners are also used such as clamping straps or spring elements.

A disadvantage of the solutions mentioned above is that the arrangement and/or attachment of the magnets to the rotor is only made possible by additional process steps or by additional mechanical fasteners, which increases the manufacturing effort and costs. Mechanical fasteners further have the disadvantage that they can affect the design of the rotor, which can have a problematic effect on the electromagnetic design of the rotor. Under certain circumstances, the mechanical fasteners themselves are made of a magnetically active material, which affects the electromagnetic design of the rotor.

To retain the magnets against centrifugal forces during high-speed rotation, typically at least portions of the attachment structures are arranged radially outwardly from the magnets. This increases the distance between the magnets of the rotor and the stator and reduces the strength of the interaction between the magnetic/electromagnetic fields of the rotor and stator and, consequently, the efficiency of the motor.

### SUMMARY

Aspects of the present disclosure are directed to an electric motor including a stator, and a rotor supported for rotation within the stator. The rotor includes a rotor body having a plurality of radially extending magnet receiving slots opening to an outer circumference of the rotor, and a plurality of magnets received in the magnet receiving slots. An outer circumference of the rotor includes surfaces of the magnets and the rotor body.

Each magnet receiving slot and each magnet can have interlocking profiles that restrict radial movement of the magnet. The interlocking profiles can include a first structure associated with each magnet receiving slot and a second structure associated with each magnet. The first structure can include a recess or protrusion and the second structure can include a corresponding protrusion or recess.

The magnet receiving slots can include first and second radially extending sidewalls, and the first structure can be defined by one of the sidewalls. The recess or protrusion of the first structure can have a rectangular cross-section. The second structure can include an overmolded material, and the overmolded material can define the second structure. The overmolded material can include a plastic material. The magnets can be in contact with an air gap between the stator and rotor.

In accordance with another aspect, a rotor for an electric motor comprises a rotor body having a plurality of radially extending magnet receiving slots opening to an outer circumference of the rotor, and a plurality of magnets received in the magnet receiving slots. An outer circumference of the rotor includes surfaces of the magnets and the rotor body.

Each magnet receiving slot and each magnet can include interlocking profiles that restrict radial movement of the magnet. The interlocking profiles can include a first structure associated with each magnet receiving slot and a second structure associated with each magnet. The first structure can include a recess or protrusion and the second structure can include a corresponding protrusion or recess. The magnet receiving slots can include first and second radially extending sidewalls, and the first structure can be defined by at least one of the sidewalls. The recess and protrusion can have mating rectangular cross-sectional shapes. The second structure can include an overmolded material, and the overmolded material can define the second structure. The overmolded material can include a plastic material.

In accordance with another aspect, a method of attaching permanent magnets to a rotor for an electric motor comprises providing a rotor having a rotor body with a plurality of radially extending magnet receiving slots opening to an outer circumference of the rotor, each magnetic receiving slot having a first structure, providing a plurality of magnets, each magnet having a second structure adapted to interlock with a first structure of a respective magnet receiving slots, inserting the magnets into the magnet receiving slots of the rotor body so that the first and second structures interlock. The magnets are restricted from radial movement by the first and second structures.

### BRIEF DESCRIPTION OF THE DRAWING(S)

The foregoing Summary and the following Detailed Description will be better understood when read in conjunction with the appended drawings, which illustrate a preferred embodiment of the disclosure. In the drawings:

FIG. 1 is a schematic illustration of an exemplary electric motor assembly having a stator and a rotor in accordance with the present disclosure;

FIG. 2 is an enlarged portion of FIG. 1

FIG. 3 is a schematic illustration of an exemplary rotor in accordance with the present disclosure, and;

FIG. 4 is a schematic illustration of an exemplary magnet in accordance with the present disclosure.

### DETAILED DESCRIPTION OF THE PREFERRED EMBODIMENT(S)

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

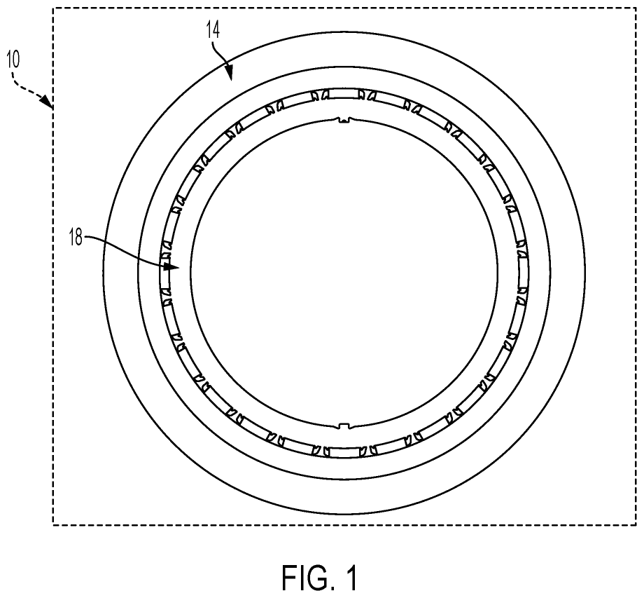

In FIG. 1, an exemplary electric motor is illustrated an identified generally by reference numeral 10. The electric motor 10 includes a stator 14 and a rotor 18 supported for rotation within the stator 14.

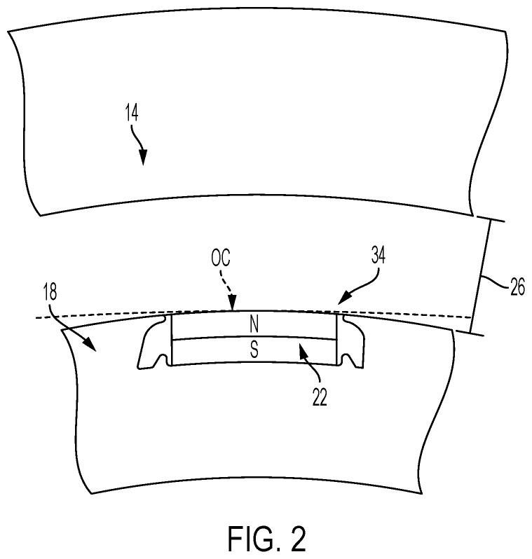

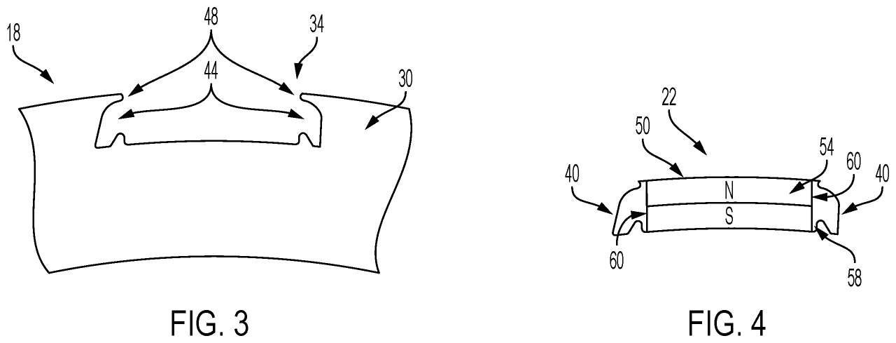

With additional reference to FIGS. 2-4, the rotor 18 supports a plurality of magnets 22 spaced about an outer circumference OC (dashed line in FIG. 1) of the rotor 18. As FIG. 1 is just a portion of the electric motor 10, it will be appreciated that a complete motor (or rotor) includes a plurality of magnets 22 spaced circumferentially about the rotor. The stator 14 and the rotor 18 are separated by an air gap 26.

The rotor 18 includes a rotor body 30 having a plurality of radially extending magnet receiving slots 34 opening to the outer circumference of the rotor 18. A magnet 22 is received in each magnet receiving slot such that the outer circumference OC of the rotor 18 includes surfaces of the magnets 22 and the rotor body 30.

Each magnet receiving slot 34 and each magnet 22 have interlocking profiles that restrict radial movement of the magnet 22 relative to the rotor body 30. In the illustrated example, the magnets 22 include protrusions 40 adapting to be received in corresponding recesses 44 of the sidewall 48 of the magnet receiving slots 34. In this regard, the magnets 22 can be inserted into the magnet receiving slots 34 along an axial direction. A radially outer surface 50 of each magnet 22 defines at least a portion of the outer circumference OC of the rotor 18 and is exposed to the air gap such that the fluid in the air gap contacts the magnetic material 54 comprising the magnet 22.

The protrusions 40 of the exemplary embodiment have a rectangular cross-sectional shape. In one example, the protrusions 40 are formed by overmolding a plastic material 58 on opposite circumferential end faces 60 of the magnetic material 54 to define the protrusions 40. In the illustrated example, the plastic material 58 covers the entirety of the circumferential end faces 60 of the magnet 22.

It will be appreciated that other methods of forming the protrusions can be implemented without departing from the scope of the present disclosure. In addition, other interlocking structures of the magnet receiving slots 34 and magnets 22 can be provided in addition or in alternative to the illustrated rectangular protrusions 40 and recess 44.

Aspects of the present disclosure allow the magnets 22 to be supported by the rotor body 30 in closer proximity to the stator, and without intervening structure between the radially outer surfaces of the magnets 22 and the stator 14, than conventional rotor/magnet constructions.

### LOG OF REFERENCE NUMERALS

10 electric motor
14 stator
18 rotor
22 magnets
30 rotor body
34 magnet receiving slots
40 protrusions
44 recesses
48 sidewall
50 outer surface of magnet
54 magnetic material
60 circumferential end face
OC outer circumference of rotor

What is claimed is:

1. An electric motor comprising:
a stator; and
a rotor supported for rotation within the stator;
wherein the rotor includes a rotor body having a plurality of radially extending magnet receiving slots opening to an outer circumference of the rotor, and a plurality of magnets received in the magnet receiving slots; and
wherein an outer circumference of the rotor includes surfaces of the magnets and the rotor body.

2. The electric motor according to claim 1, wherein each magnet receiving slot and each magnet have interlocking profiles that restrict radial movement of the magnet.

3. The electric motor according to claim 2, wherein the interlocking profiles include a first structure associated with each magnet receiving slot and a second structure associated with each magnet.

4. The electric motor according to claim 3, wherein the first structure includes a recess or protrusion and the second structure includes a corresponding protrusion or recess.

5. The electric motor according to claim 4, wherein the magnet receiving slots include first and second radially extending sidewalls, and wherein the first structure is defined by one of the sidewalls.

6. The electric motor according to claim 5, wherein the recess or protrusion of the first structure has a rectangular cross-section.

7. The electric motor according to claim 6, wherein the second structure includes an overmolded material, and wherein the overmolded material defines the second structure.

8. The electric motor according to claim 7, wherein the overmolded material includes a plastic material.

9. The electric motor according to claim 1, further comprising an air gap between outer circumference of the rotor and the stator, wherein the magnets are in contact with the air gap.

10. A rotor for an electric motor comprising:
a rotor body having a plurality of radially extending magnet receiving slots opening to an outer circumference of the rotor; and
a plurality of magnets received in the magnet receiving slots;
wherein an outer circumference of the rotor includes surfaces of the magnets and the rotor body.

11. The rotor according to claim 10, wherein each magnet receiving slot and each magnet include interlocking profiles that restrict radial movement of the magnet.

12. The rotor according to claim 11, wherein the interlocking profiles include a first structure associated with each magnet receiving slot and a second structure associated with each magnet.

13. The rotor according to claim 12, wherein the first structure includes a recess or protrusion and the second structure includes a corresponding protrusion or recess.

14. The rotor according to claim 13, wherein the magnet receiving slots include first and second radially extending sidewall, and wherein the first structure is defined by one of the sidewalls.

15. The rotor according to claim 14, wherein the recess or protrusion of the first structure has a rectangular cross-section.

16. The rotor according to claim 15, wherein the second structure includes an overmolded material, and wherein the overmolded material defines the second structure.

17. The rotor according to claim 16, wherein the overmolded material is includes a plastic material.

18. A method of attaching permanent magnets to a rotor for an electric motor, the method comprising:
providing a rotor having a rotor body with a plurality of radially extending magnet receiving slots opening to an outer circumference of the rotor, each magnetic receiving slot having a first structure;
providing a plurality of magnets, each magnet having a second structure adapted to interlock with a first structure of a respective magnet receiving slots;
inserting the magnets into the magnet receiving slots of the rotor body so that the first and second structures interlock;
whereby the magnets are restricted from radial movement by the first and second structures.
